(19) United States
(12) Patent Application Publication
(10) Pub. No.: US 2012/0287987 A1
(43) Pub. Date: Nov. 15, 2012

(54) Coding of Scene Changes Using Picture Dropping

(76) Inventors: Madhukar Budagavi, Plano, TX (US); Do-Kyoung Kwon, Allen, TX (US)

(21) Appl. No.: 13/107,291

(22) Filed: May 13, 2011

(51) Int. Cl. H04N 7/26

(52) U.S. Cl. 375/240.02; 375/E07.026

(57) ABSTRACT

A method for encoding a video sequence in a video encoder to generate a compressed bit stream is provided that includes coding a picture in the video sequence, detecting a scene change in the picture, and responsive to detecting the scene change, dropping the picture, signaling repetition of another picture in the compressed bit stream, and intra-coding a subsequent picture in the video sequence.

### BACKGROUND OF THE INVENTION

1. Field of the Invention

Embodiments of the present invention generally relate to a method and apparatus for coding scene changes using picture dropping.

2. Description of the Related Art

The demand for digital video products continues to increase. Some examples of applications for digital video include video communication, security and surveillance, industrial automation, and entertainment (e.g., DV, HDTV, satellite TV, set-top boxes, Internet video streaming, video gaming devices, digital cameras, cellular telephones, video jukeboxes, high-end displays and personal video recorders). Further, video applications are becoming increasingly mobile as a result of higher computation power in handsets, advances in battery technology, and high-speed wireless connectivity.

Video compression, i.e., video coding, is an essential enabler for digital video products as it enables the storage and transmission of digital video. In general, video coding standards such as MPEG-2, MPEG-4, H.264/AVC, etc. and the standard currently under development, HEVC, define a hybrid video coding technique of block motion compensation (prediction) plus transform coding of prediction error. Block motion compensation is used to remove temporal redundancy between successive pictures (frames or fields) by prediction from prior pictures, whereas transform coding is used to remove spatial redundancy within each block of a picture. In such techniques, pictures may be intra-coded or inter-coded, i.e., predicted from a previous picture or predicted from a previous picture and a following picture.

Video coding on resource constrained devices such as camera phones and camcorders is typically performed in a single pass with no preprocessing. In such video coders, scene changes in a video sequence can lead to quality degradation when the resulting compressed bit stream is decoded. If a scene change occurs in an inter-coded picture, coding efficiency of that picture is adversely affected as there may be little or no information in the reference picture(s) to use for prediction. This coding inefficiency leads to poor reconstruction quality for the picture when rate control is used. Further, the poor quality of that picture propagates in time to subsequent inter-coded pictures, thus leading to noticeable visual artifacts when the resulting compressed bit stream is decoded.

### SUMMARY

Embodiments of the present invention relate to a method and apparatus for coding scene changes using picture dropping. The method includes coding a picture in the video sequence, detecting a scene change in the picture, and responsive to detecting the scene change, dropping the picture, signaling repetition of another picture in the compressed bit stream, and intra-coding a subsequent picture in the video sequence.

### BRIEF DESCRIPTION OF THE DRAWINGS

Particular embodiments will now be described, by way of example only, and with reference to the accompanying drawings:

FIG. 1 shows a block diagram of a digital system in accordance with one or more embodiments;

FIGS. 2A and 2B show block diagrams of a video encoder in accordance with one or more embodiments;

FIG. 3 shows a flow diagram of a method in accordance with one or more embodiments;

FIGS. 4A, 4B, 5A, and 5B show examples in accordance with one or more embodiments; and

FIG. 6 shows a block diagram of an illustrative digital system in accordance with one or more embodiments.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

As used herein, the term “picture” refers to a frame or a field of a frame. A frame is a complete image captured during a known time interval. When a video sequence is in progressive format, the term picture refers to a complete frame. When a video sequence is in interlaced format, each frame is composed of a field of odd-numbered scanning lines followed by a field of even-numbered lines. Each of these fields is a picture. Further, an I-picture is an intra-coded picture, a P-picture is an inter-coded picture predicted from another I-picture or P-picture, e.g., a previous I-picture or P-picture, and a B-picture is an inter-coded picture predicted using two pictures, e.g., a previous I-picture or P-picture and a following I-picture or P-picture. In general, a group of pictures (GOP) is a group of successive pictures in a video sequence and a GOP coding structure specifies how each picture in the GOP is to be coded, i.e., whether a given picture is to be coded as an I-picture, P-picture, or B-picture.

If the GOP coding structure is non-hierarchical, each GOP begins with an I-picture and includes all pictures until the next I-picture. The pictures between the two I-pictures may be some defined sequence of P-pictures and/or B-pictures, depending on the particular GOP coding structure. If the GOP coding structure is hierarchical, e.g., hierarchical-B, a GOP is defined to be a key picture and all pictures that are temporally located between that key picture and the previous key picture. A key picture may be intra-coded, i.e., an I-picture, or inter-coded using a previous key picture, i.e., a P-picture. The other pictures in the GOP are hierarchically predicted.

In the descriptions of embodiments below, GOP coding structures may be referred to as IPPP and IBBP. The use of IPPP and IBBP is not intended to limit the length of a GOP coding structure. Any number of P-pictures may be included in an IPPP GOP coding structure and any number of B/P pictures may be included in an IBBP GOP coding structure.

Embodiments described herein provide for improved quality in the coding of scene changes in a video sequence. More specifically, in some embodiments, if a scene change is detected after coding a P-picture in a GOP coding structure, e.g., IPPP, IBBP, or hierarchical-B, the P-picture is dropped and repetition of a picture is signaled in the output compressed bit stream. In an IPPP GOP, the repeated picture is the picture preceding the dropped P-picture in the GOP. In an IBBP GOP, the repeated picture is the picture following the dropped P-picture in the GOP. The next picture in the GOP coding structure after the dropped P-picture is intra-coded. Further, if the new intra-coded picture is defined as a B-picture in the GOP coding structure, references for the B-pictures preceding the intra-coded picture are changed to refer to the intra-coded picture rather than the dropped P-picture and the B-pictures are coded. References for B/P pictures following the new intra-coded picture in the GOP coding structure are also changed as needed. The picture types of pictures following the new intra-coded picture may also be modified as needed to maintain the number of coded B-pictures between I/P pictures in the GOP coding structure.

In some embodiments, rate control automatically allocates bits saved by dropping the P-picture to the new intra-coded picture when determining the quantization parameter (QP) for the intra-coded picture, thus improving the quality of the intra-coded picture. In some embodiments, more than one inter-coded picture may be dropped and the previous picture repeated to increase the number of bits available for allocation to the new intra-coded picture. Rate control may then allocate the saved bits to the new intra-coded picture when determining the QP for that picture. In some embodiments, in addition to allocating bits saved by dropping the P-picture to the new intra-coded picture, rate control may also allocate bits previously allocated to pictures following the new intra-coded picture in the GOP coding structure to the new intra-coded picture, thus reducing the bit budget for the following pictures.

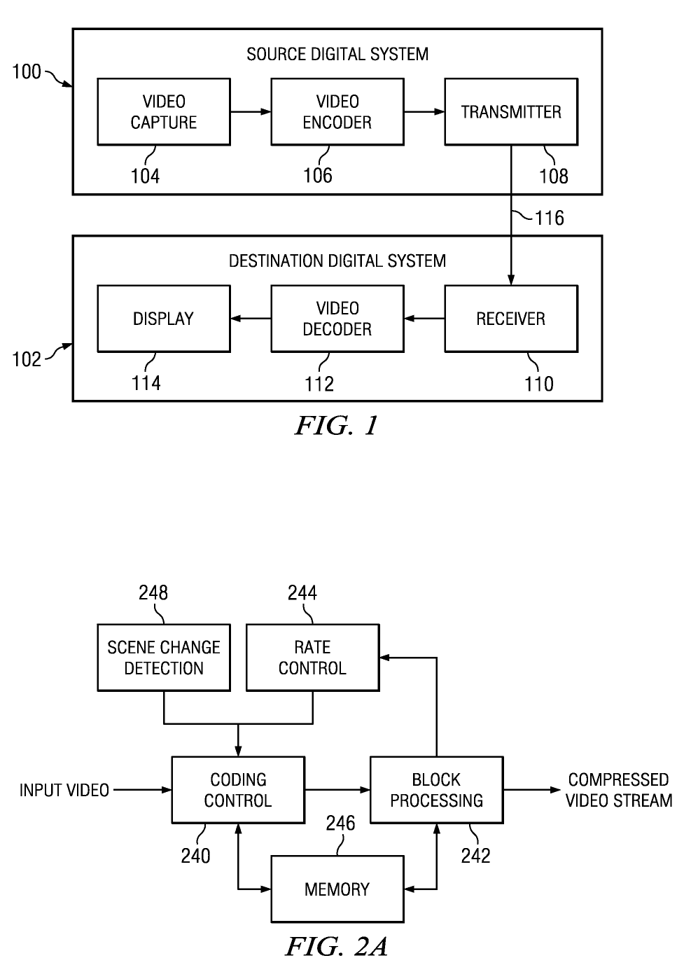

FIG. 1 shows a block diagram of a digital system in accordance with one or more embodiments. The system includes a source digital system 100 that transmits encoded video sequences to a destination digital system 102 via a communication channel 116. The source digital system 100 includes a video capture component 104, a video encoder component 106 and a transmitter component 108. The video capture component 104 is configured to provide a video sequence to be encoded by the video encoder component 106. The video capture component 104 may be for example, a video camera, a video archive, or a video feed from a video content provider. In some embodiments, the video capture component 104 may generate computer graphics as the video sequence, or a combination of live video, archived video, and/or computer-generated video.

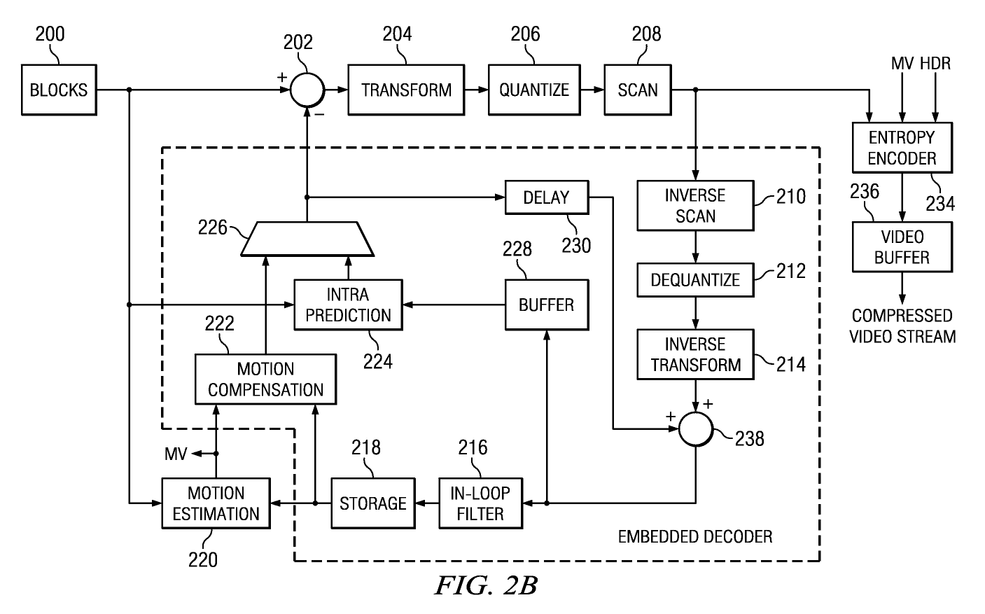

The video encoder component 106 receives a video sequence from the video capture component 104 and encodes it for transmission by the transmitter component 108. The video encoder component 106 receives the video sequence from the video capture component 104 as a sequence of frames, divides the frames into coding blocks, e.g., macroblocks, and encodes the video data in the coding blocks. The video encoder component 106 may be configured to apply one or more techniques for coding of scene changes during the encoding process as described herein. Embodiments of the video encoder component 106 are described in more detail below in reference to FIGS. 2A and 2B.

The transmitter component 108 transmits the encoded video data to the destination digital system 102 via the communication channel 116. The communication channel 116 may be any communication medium, or combination of communication media suitable for transmission of the encoded video sequence, such as, for example, wired or wireless communication media, a local area network, or a wide area network.

The destination digital system 102 includes a receiver component 110, a video decoder component 112 and a display component 114. The receiver component 110 receives the encoded video data from the source digital system 100 via the communication channel 116 and provides the encoded video data to the video decoder component 112 for decoding. The video decoder component 112 reverses the encoding process performed by the video encoder component 106 to reconstruct the coding blocks of the video sequence. The reconstructed video sequence is displayed on the display component 114. The display component 114 may be any suitable display device such as, for example, a plasma display, a liquid crystal display (LCD), a light emitting diode (LED) display, etc.

In some embodiments, the source digital system 100 may also include a receiver component and a video decoder component and/or the destination digital system 102 may include a transmitter component and a video encoder component for transmission of video sequences both directions for video steaming, video broadcasting, and video telephony. Further, the video encoder component 106 and the video decoder component 112 may perform encoding and decoding in accordance with one or more video compression standards. The video encoder component 106 and the video decoder component 112 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

FIGS. 2A and 2B show block diagrams of a video encoder, e.g., the video encoder 106 of FIG. 1, configured to apply one or more techniques for coding scene changes as described herein. FIG. 2A shows a high level block diagram of the video encoder and FIG. 2B shows a block diagram of the block processing component 242 of the video encoder.

As shown in FIG. 2A, a video encoder includes a coding control component 240, a block processing component 242, a rate control component 244, a scene detection component 248, and a memory 246. The memory 246 may be internal memory, external memory, or a combination thereof. The memory 246 may be used, for example, to store information for communication between the various components of the video encoder.

An input digital video sequence is provided to the coding control component 240. The coding control component 240 sequences the various operations of the video encoder. For example, the coding control component 240 performs any processing on the input video sequence that is to be done at the frame level, such as determining the coding type (I, P, or B), i.e., prediction mode, of each picture based on the GOP coding structure, e.g., IPPP, IBBP, hierarchical-B, being used. The coding control component 240 also divides each picture into coding blocks for further processing by the block processing component 242. As is explained in more detail below, the coding control component 240 receives various information from the block processing component 242 as coding units are processed, from the scene detection component 248, and the rate control component 244, and uses this information to control the operation of various components in the video encoder. For example, the coding control component 240 provides information regarding QPs determined by the rate control component 244 to various components of the block processing component 242 as needed.

The rate control component 244 determines a quantization parameter (QP) for each coding block in a picture based on various rate control criteria and provides the QPs to the coding control component 240. As is explained in more detail herein, the rate control component 244 may also receive information from the coding control component 240 that is used in the determination of the QPs. The rate control component 244 may use any suitable rate control algorithm that determines QPs based on a budget of bits allocated to pictures in GOPs. For example, a rate control algorithm that allocates a budget of bits to each GOP, individual picture, and sub-picture in a video sequence may be used. Based on a target bit rate and the current fullness of a virtual buffer used to model decoder constraints, a target bit rate may be allocated to a GOP. This GOP target bit rate is then used to allocate bits to pictures in the GOP. The picture bit budget may then be used to allocate bits to sub-pictures such as, for example, rows of coding blocks, contiguous sets of coding blocks, and/or individual coding blocks.

The scene change detection component 248 determines if there is a scene change in a picture based on information received from the coding control component 240 as the picture is coded by the block processing component 242. The scene change detection component 248 notifies the coding control component 240 when a scene change is detected. The scene change detection component 248 may use any suitable scene detection algorithm. For example, the scene detection component 248 may detect a scene change in a picture if the number of intra-coded coding blocks in a picture is very high, thus indicating that the content of the picture is very different from the content of the previous picture. In another example, the scene detection component 248 may detect a scene change in a picture if the motion estimation error in a picture is higher than a threshold, which would indicate that there was not a good match between a large number of coding blocks in the picture and a reference picture.

The block processing component 242 receives coding blocks from the coding control component 240 and encodes the blocks under the control of the coding control component 240 to generate the compressed video stream. FIG. 2B shows the basic coding architecture of the block processing component 242. The coding blocks 200 from the coding control component 240 are provided as one input of a motion estimation component 220, as one input of an intra prediction component 224, and to a positive input of a combiner 202 (e.g., adder or subtractor or the like). Further, although not specifically shown, the prediction mode of each picture as selected by the coding control component 240 is provided to a mode selector component, and the entropy encoder 234.

The storage component 218 provides reference data to the motion estimation component 220 and to the motion compensation component 222. The reference data may include one or more previously encoded and decoded coding blocks, i.e., reconstructed coding blocks.

The motion estimation component 220 provides motion estimation information to the motion compensation component 222 and the entropy encoder 234. More specifically, the motion estimation component 220 performs tests on coding blocks based on multiple temporal prediction modes using reference data from storage 218 to choose the best motion vector(s)/prediction mode based on a coding cost. To perform the tests, the motion estimation component 220 may divide each coding block into prediction units according to the unit sizes of prediction modes and calculate the coding costs for each prediction mode for each coding block.

The motion estimation component 220 provides the selected motion vector (MV) or vectors and the selected prediction mode for each inter predicted coding block to the motion compensation component 223 and the selected motion vector (MV) to the entropy encoder 234. The motion compensation component 222 provides motion compensated inter-prediction information to a selector switch 226 that includes motion compensated inter-predicted coding blocks and the selected temporal prediction modes for the inter-predicted coding blocks. The coding costs of the inter-predicted coding blocks are also provided to the mode selector component (not shown).

The intra prediction component 224 provides intra-prediction information to the selector switch 226 that includes intra-predicted coding blocks and the corresponding spatial prediction modes. That is, the intra prediction component 224 performs spatial prediction in which tests based on multiple spatial prediction modes are performed on coding blocks using previously encoded neighboring coding blocks of the picture from the buffer 228 to choose the best spatial prediction mode for generating an intra-predicted coding block based on a coding cost. To perform the tests, the intra prediction component 224 may divide each coding block into prediction units according to the unit sizes of the spatial prediction modes and calculate the coding costs for each prediction mode for each coding block. Although not specifically shown, the spatial prediction mode of each intra-predicted coding block provided to the selector switch 226 is also provided to the transform component 204. Further, the coding costs of the intra-predicted coding blocks are also provided to the mode selector component.

The selector switch 226 selects between the motion compensated inter-predicted coding blocks from the motion compensation component 222 and the intra-predicted coding blocks from the intra prediction component 224 based on the coding costs of the coding blocks and the picture prediction mode provided by the mode selector component. The output of the selector switch 226, i.e., the predicted coding block, is provided to a negative input of the combiner 202 and to a delay component 230. The output of the delay component 230 is provided to another combiner (i.e., an adder) 238. The combiner 202 subtracts the predicted coding block from the current coding block to provide a residual coding block to the transform component 204. The resulting residual coding block is a set of pixel difference values that quantify differences between pixel values of the original coding block and the predicted coding block.

The transform component 204 performs unit transforms on the residual coding blocks to convert the residual pixel values to transform coefficients and provides the transform coefficients to a quantize component 206. The quantize component 206 quantizes the transform coefficients of the residual coding blocks based on QPs provided by the coding control component 240. For example, the quantize component 206 may divide the values of the transform coefficients by a quantization scale (Qs) derived from a QP value. In some embodiments, the quantize component 206 represents the coefficients by using a desired number of quantization steps, the number of steps used (or correspondingly the value of Qs) determining the number of bits used to represent the residuals. Other algorithms for quantization such as rate-distortion optimized quantization may also be used by the quantize component 206.

Because the DCT transform redistributes the energy of the residual signal into the frequency domain, the quantized transform coefficients are taken out of their scan ordering by a scan component 208 and arranged by significance, such as, for example, beginning with the more significant coefficients followed by the less significant. The ordered quantized transform coefficients for a coding block provided via the scan component 208 along with header information for the coding block and the QP used are coded by the entropy encoder 234, which provides a compressed bit stream to a video buffer 236 for transmission or storage. The entropy coding performed by the entropy encoder 234 may use any suitable entropy encoding technique, such as, for example, context adaptive variable length coding (CAVLC), context adaptive binary arithmetic coding (CABAC), run length coding, etc.

Inside the block processing component 242 is an embedded decoder. As any compliant decoder is expected to reconstruct an image from a compressed bit stream, the embedded decoder provides the same utility to the video encoder. Knowledge of the reconstructed input allows the video encoder to transmit the appropriate residual energy to compose subsequent frames. To determine the reconstructed input, i.e., reference data, the ordered quantized transform coefficients for a coding block provided via the scan component 208 are returned to their original post-transform arrangement by an inverse scan component 210, the output of which is provided to a dequantize component 212, which outputs estimated transformed information, i.e., an estimated or reconstructed version of the transform result from the transform component 204. The dequantize component 212 performs inverse quantization on the quantized transform coefficients based on the QP used by the quantize component 206. The estimated transformed information is provided to the inverse transform component 214, which outputs estimated residual information which represents a reconstructed version of a residual coding block. The reconstructed residual coding block is provided to the combiner 238.

The combiner 238 adds the delayed selected coding block to the reconstructed residual coding block to generate an unfiltered reconstructed coding block, which becomes part of reconstructed picture information. The reconstructed picture information is provided via a buffer 228 to the intra prediction component 224 and to a filter component 216. The filter component 216 is an in-loop filter which filters the reconstructed frame information and provides filtered reconstructed coding blocks, i.e., reference data, to the storage component 218.

In operation, the coding control component 240 receives frames of a video sequence and provides coding blocks of each picture to the block processing component 242 for coding along with the appropriate picture prediction mode as per the GOP coding structure. As the coding blocks for a picture are coded, the coding control component 240 provides information regarding the SADs of each inter-predicted coding block and the prediction type of each coding block as determined by the motion estimation component 220 to the scene change detection component 248.

The scene change detection component 248 uses the information provided to determine if a scene change has occurred in the picture and notifies the coding control component 240 if a scene change is detected. In some embodiments, the scene change detection component 248 detects scene changes in P-pictures and not in I-pictures or B-pictures. Note that in an IBBP GOP coding structure, a P-picture is coded before any of the B-pictures that reference it. Thus, even if the scene change actually occurred in one of the referencing B-pictures, it will first be detected in the P-picture. If no scene change is detected, the coded picture is output as part of the compressed video stream and the next picture in the video sequence is processed.

If the scene change detection component 248 detects a scene change, the coding control component 240 performs special actions to improve the quality of the coded pictures in the GOP in view of the scene change. If the GOP coding structure is IPPP, the coding control component 240 causes the current picture, i.e., the picture in which the scene change is detected, to be dropped and, in its place in the compressed video stream, inserts an indication that the previous picture is to be repeated. Repetition of the previous picture may be signaled, for example, by using vop_coded=0 in MPEG4, by using skip mode in other video coding standards to skip each coding block in the picture, or by increasing the display time of the subsequent picture. The coding control component 240 then causes the subsequent picture in the GOP to be intra-coded.

If the GOP coding structure is IBBP, the coding control component 240 causes the current picture, i.e., the picture in which the scene change is detected, to be dropped, and causes the subsequent picture in the GOP, which would have been a B-picture, to be intra-coded. The coding control component 240 then causes the B-pictures that would have been coded with reference to the dropped P-picture to be coded with reference to the new I-picture. After these B-pictures are coded, the coding control component 240 then inserts an indication in the compressed video stream that the next picture, i.e., the new intra-coded picture, is to be repeated. Note that this indication takes the place of the dropped P-picture. Repetition of the next picture may be indicated in H.264, for example, by coding the dropped P-picture as a B-picture using skip prediction, i.e., using mb_type=B_L1_{—}16×16 and a motion vector of (0,0) for all macroblocks in the picture. Setting mb_type=B_L1_{—}16×16 indicates that a macroblock has only one 16×16 backward motion vector.

The coding control component 240 also adjusts the references of subsequent pictures in the GOP as needed. In some embodiments, the coding control component 240 may also change the picture types of subsequent picture in the GOP in order to maintain the number of coded B-pictures between key pictures in the GOP coding structure.

The coding control component 240 also notifies the rate control component 244 of the coding changes. In some embodiments, the rate control component 244 automatically allocates bits saved by dropping the P-picture to the new intra-coded picture when determining the QP for the intra-coded picture. In some embodiments, if the bits saved by dropping the P-picture are not enough to sufficiently improve the quality of the intra-coded picture, the rate control component 244 may request that the coding control component 240 causes one or more additional pictures in the GOP to be dropped to further increase the bit budget for the intra-coded picture. In some embodiments, if the bits saved by dropping the P-picture are not enough to sufficiently improve the quality of the intra-coded picture, the rate control component 244 may reallocate a portion of the bits allocated to subsequent pictures in the GOP to the intra-coded picture. For example, let Np be the number of pictures after the intra-coded picture in the GOP and let Rp be the number of bits allocated to those pictures. To improve the quality of the intra-coded picture and successive pictures in the GOP that rely on the intra-coded picture, some portion of Rp is reallocated to the intra-coded picture. That is, the intra-coded picture will have a bit budget of its original bit budget plus the bits saved by dropping the P-picture plus alpha*Rp and successive Np pictures will have share a bit budget of (1−alpha)*Rp, where 0<=alpha<1.

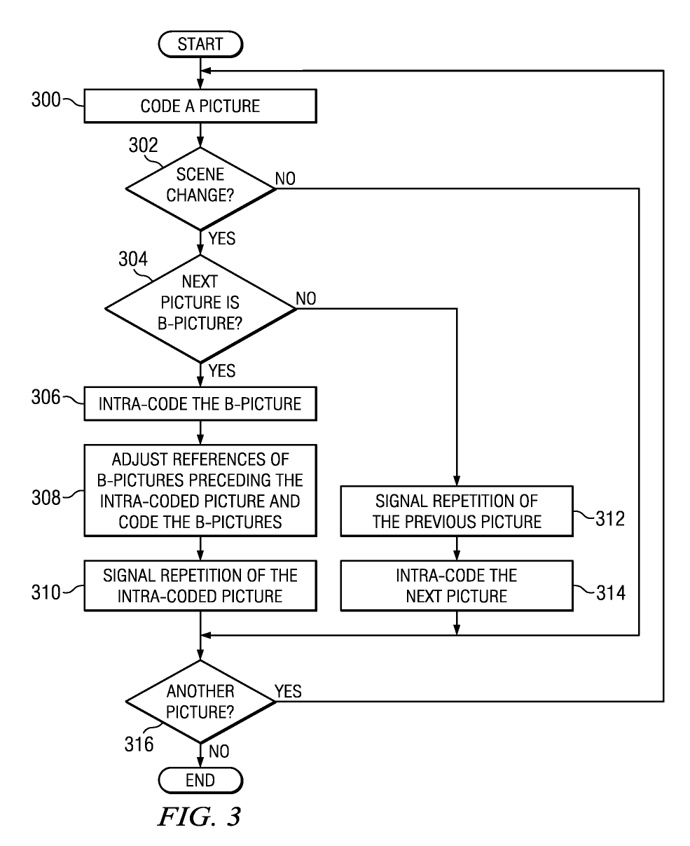

FIG. 3 is a flow diagram of a method for coding a scene change in a video sequence in a video encoder in accordance with one or more embodiments. Initially, a picture in the video sequence is coded 300. After the picture is coded, a determination is made as to whether a scene change was detected in the picture 302. In some embodiments, a scene change determination is made in P-pictures and not in I-pictures or B-pictures. Any suitable technique may be used for detecting the scene change. In some embodiments, the SADs of inter-coded coding blocks in the picture and the ratio of inter-coded to intra-coded coding blocks in the picture are considered in the scene change determination. If a scene change is not detected, coding continues with the next picture in the video sequence, if any 316.

If a scene change is detected 302, then a determination is made as to the type of the next picture in the GOP 304. If the next picture is a B-picture, then an IBBP GOP coding structure is being used for the encoding of the video sequence. Otherwise, an IPPP GOP coding structure is being used.

If the next picture is not a B-picture, then repetition of the previous picture in the GOP is signaled in the compressed bit stream and the picture in which the scene change was detected is dropped 312. Further, the next picture in the video sequence is intra-coded 314. Coding of the video sequence then continues with the next picture in the video sequence, if any 316.

If the next picture is a B-picture, then that picture is intra-coded 306. Then, the references of the B-pictures preceding the intra-coded picture in the GOP are adjusted as needed to refer to the intra-coded picture instead of the P-picture, and these B-pictures are coded 308. Further, the P-picture is dropped and repetition of the intra-coded picture is signaled in the compressed bit stream to replace the dropped P-picture 310. Although not specifically shown, references of pictures following the dropped P-picture are also adjusted as needed to refer to the intra-coded pictured instead. Further, in some embodiments, the types of subsequent pictures may be changed to maintain the number of coded B-pictures between key pictures in the GOP coding structure.

Although not specifically shown in FIG. 3, rate control in the video controller may adapt the bit budget for the intra-coded picture responsive to the dropped P-picture. In some embodiments, rate control automatically allocates any bits saved by dropping the P-picture to the new intra-coded picture when determining the QP for the picture. In some embodiments, if the increased bit budget for the new intra-coded picture in view of the dropped P-picture will not result in sufficient quality of the intra-coded picture, one or more additional pictures in the GOP may be dropped to increase the bit budget for the intra-coded pictured. In some embodiment, if the increased bit budget for the new intra-coded picture in view of the dropped P-picture will not result in sufficient quality of the intra-coded picture, the bits allocated to subsequent pictures in the GOP may be reallocated to the intra-coded picture as previously described.

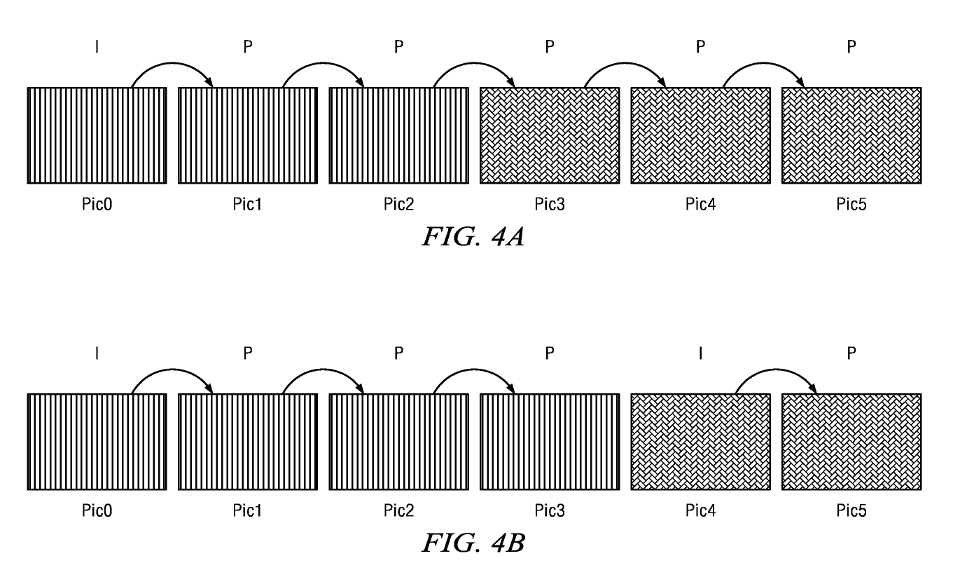

FIGS. 4A and 4B show an example of coding a scene change in an IPPP GOP coding structure in accordance with one or more embodiments. In FIG. 4A, a scene change is detected in Pic3. Since this scene change is not detected before the actual coding of Pic3, Pic3 is initially coded as a P-picture. This is an inefficient way of coding Pic3 since there is nothing to predict from Pic2 as it is part of another scene. This inefficiency in coding leads to poor reconstruction quality of Pic3. Since Pic4, Pic5, etc. are also P-pictures, the poor quality of Pic3 will propagate in time to these pictures, thus causing noticeable visual artifacts. As shown in FIG. 4B, the scene change in Pic3 is detected. Instead of coding a poor quality Pic3, the previous picture, Pic2, is repeated. The bits saved by repeating Pic2 are then used to improve the quality of the next picture which is coded as I-picture.

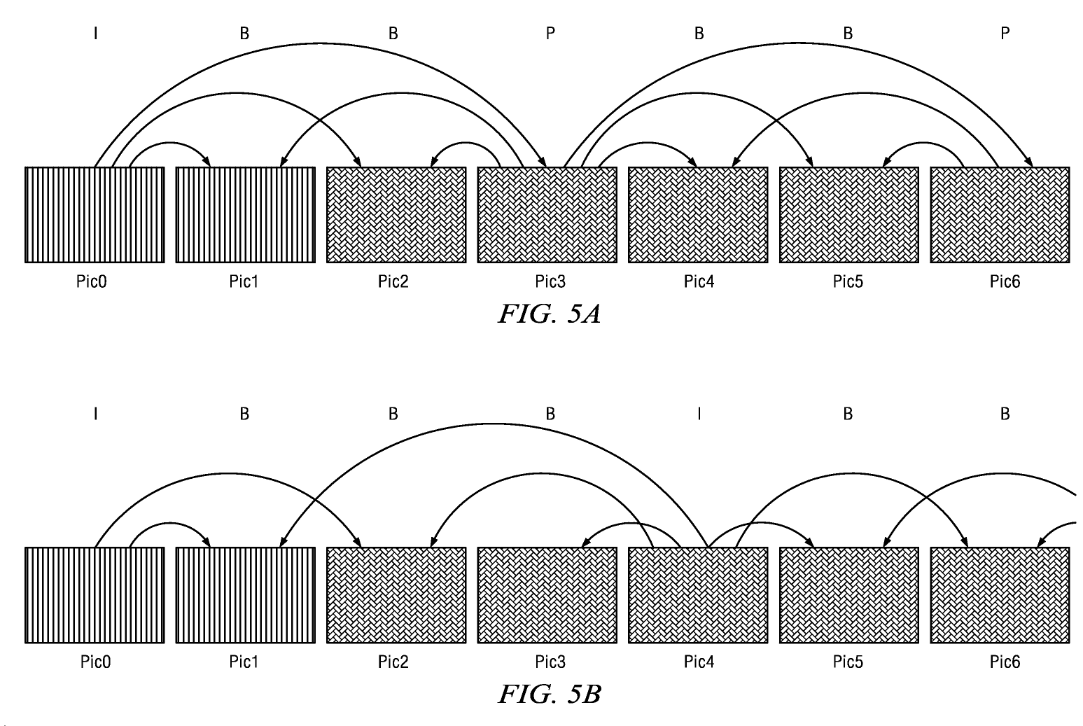

FIGS. 5A and 5B show an example of coding a scene change in and IBBP GOP coding structure. In FIG. 5A, a scene change occurs at Pic2. However, Pic3, a P-picture, is coded first in coding order and the scene change is detected in Pic3. This is an inefficient way of coding Pic3 since there is nothing to predict from Pic0 as it is part of another scene. Further, other pictures dependent upon Pic3 such as Pic2, Pic4, Pic5, and Pic6 will have poor quality. As shown in FIG. 5B, the scene change in Pic3 is detected. Pic3 is coded as a B-picture using skip prediction from Pic4. As a result, Pic3 consumes very few bits. Pic4 is coded as I-picture using the bit budget of Pic3+Pic4 (less any bits used for the new coding of Pic3). The backward references of Pic1 and Pic2 are modified to refer to Pic4 instead of the original choice of Pic3. In addition, the backward references of Pic5 and Pic6 are modified to refer to Pic4 and the prediction type of Pic6 is changed from P to B to maintain the GOP coding structure.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device, and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

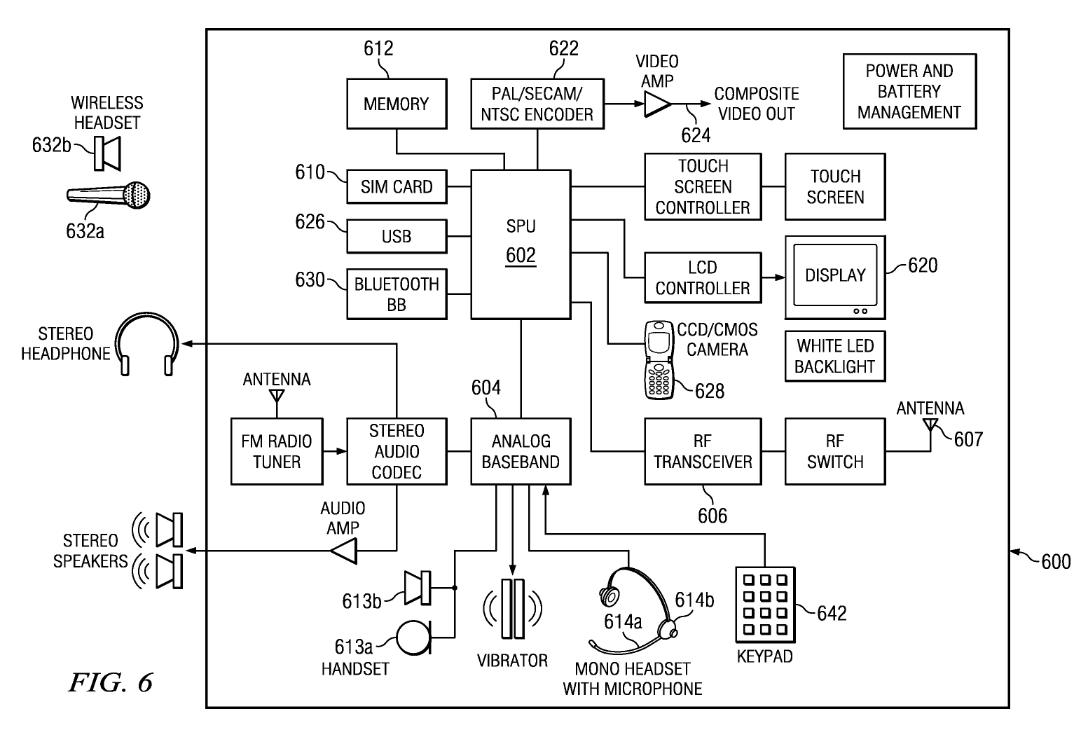

Embodiments of the methods and encoders as described herein may be implemented for virtually any type of digital system (e.g., a desk top computer, a laptop computer, a handheld device such as a mobile (i.e., cellular) phone, a personal digital assistant, a digital camera, etc.). FIG. 6 is a block diagram of a digital system (e.g., a mobile cellular telephone) 600 that may be configured to use techniques described herein.

As shown in FIG. 6, the signal processing unit (SPU) 602 includes a digital signal processing system (DSP) that includes embedded memory and security features. The analog baseband unit 604 receives a voice data stream from handset microphone 613a and sends a voice data stream to the handset mono speaker 613b. The analog baseband unit 604 also receives a voice data stream from the microphone 614a and sends a voice data stream to the mono headset 614b. The analog baseband unit 604 and the SPU 602 may be separate ICs. In many embodiments, the analog baseband unit 604 does not embed a programmable processor core, but performs processing based on configuration of audio paths, filters, gains, etc being setup by software running on the SPU 602.

The display 620 may also display pictures and video sequences received from a local camera 628, or from other sources such as the USB 626 or the memory 612. The SPU 602 may also send a video sequence to the display 620 that is received from various sources such as the cellular network via the RF transceiver 606 or the camera 626. The SPU 602 may also send a video sequence to an external video display unit via the encoder unit 622 over a composite output terminal 624. The encoder unit 622 may provide encoding according to PAL/SECAM/NTSC video standards.

The SPU 602 includes functionality to perform the computational operations required for video encoding and decoding. In one or more embodiments, the SPU 602 is configured to perform computational operations for applying one or more techniques for coding of scene changes during the encoding process as described herein. Software instructions implementing the techniques may be stored in the memory 612 and executed by the SPU 602, for example, as part of encoding video sequences captured by the local camera 628.

The steps in the flow diagrams herein are described in a specific sequence merely for illustration. Alternative embodiments using a different sequence of steps may also be implemented without departing from the scope and spirit of the present disclosure, as will be apparent to one skilled in the relevant arts by reading the disclosure provided herein.

While the invention has been described with respect to a limited number of embodiments, those skilled in the art, having benefit of this disclosure, will appreciate that other embodiments can be devised which do not depart from the scope of the invention as disclosed herein.

What is claimed is:

1. A method for encoding a video sequence in a video encoder to generate a compressed bit stream, the method comprising:
coding a picture in the video sequence;
detecting a scene change in the picture; and
responsive to detecting the scene change,
dropping the picture;
signaling repetition of another picture in the compressed bit stream, and
intra-coding a subsequent picture in the video sequence.

2. The method of claim 1, further comprising
allocating a number of bits to the picture for representing the picture in the compressed bit stream; and
increasing a number of bits allocated to the intra-coded picture for representing the intra-coded picture in the compressed bit stream by a portion of the number of bits allocated to the picture after dropping the picture.

3. The method of claim 2, further comprising dropping at least one additional picture in a group of pictures comprising the dropped picture, wherein the number of bits allocated to the intra-coded picture is increased by a portion of a number of bits allocated to the at least one additional picture.

4. The method of claim 2, further comprising reallocating to the intra-coded picture a portion of a number of bits allocated to pictures subsequent to the intra-coded picture in a group of pictures comprising the intra-coded picture and the subsequent pictures.

5. The method of claim 1, wherein signaling repetition of another picture comprises signaling repetition of a previous picture.

6. The method of claim 1, wherein signaling repetition of another picture comprises signaling repetition of the intra-coded picture.

7. The method of claim 1, further comprising adjusting a reference of at least one picture to refer to the intra-coded picture instead of the dropped picture, wherein the at least one picture is in a group of pictures comprising the dropped picture.

8. The method of claim 1, wherein the picture is a P-picture and the subsequent picture is one selected from a group consisting of a P-picture and a B-picture.

9. A digital system comprising a video encoder configured to
code a picture in a group of pictures;
detect a scene change in the picture; and
responsive to detection of the scene change,
drop the picture;
signal repetition of another picture in the group of pictures in a compressed bit stream, and
intra-code a subsequent picture in the group of pictures.

10. The digital system of claim 9, wherein the video encoder is further configured to
allocate a number of bits to the picture for representing the picture in the compressed bit stream; and
increase a number of bits allocated to the intra-coded picture for representing the intra-coded picture in the compressed bit stream by a portion of the number of bits allocated to the picture after dropping the picture.

11. The digital system of claim 10, wherein the video encoder is further configured to drop at least one additional picture in the group of pictures, wherein the number of bits for representing the intra-coded picture is increased by a portion of a number of bits allocated to the at least one additional picture.

12. The digital system of claim 10, wherein the video encoder is further configured to reallocate to the intra-coded picture a portion of a number of bits allocated to pictures subsequent to the intra-coded picture in the group of pictures.

13. The digital system of claim 9, wherein the video encoder is further configured to signal repetition of another picture by signaling repetition of one selected from a group consisting of a previous picture and the intra-coded picture.

14. The digital system of claim 9, wherein the video encoder is further configured to adjust a reference of at least one picture in the group of pictures to refer to the intra-coded picture instead of the dropped picture.

15. The digital system of claim 9, wherein the picture is a P-picture and the subsequent picture is one selected from a group consisting of a P-picture and a B-picture.

16. A computer readable medium storing instructions for coding of a video sequence to generate a compressed bit stream, wherein execution of the instructions by a processor in a video encoder causes the video encoder to perform the actions of:
coding a picture in a group of pictures in the video sequence;
detecting a scene change in the picture; and
responsive to detecting the scene change,
dropping the picture;
signaling repetition of another picture in the group of pictures in the compressed bit stream, and
intra-coding a subsequent picture in the group of pictures.

17. The computer readable medium of claim 16, wherein execution of the instructions further causes the video encoder to perform the actions of:
allocating a number of bits to the picture for representing the picture in the compressed bit stream; and
increasing a number of bits allocated to the intra-coded picture for representing the intra-coded picture in the compressed bit stream by a portion of the number of bits allocated to the picture after dropping the picture.

18. The computer readable medium of claim 17, wherein execution of the instructions further causes the video encoder to perform the actions of one selected from a group consisting of: dropping at least one additional picture in the group of pictures, wherein the number of bits allocated to the intra-coded picture is increased by a portion of a number of bits allocated to the at least one additional picture, and reallocating to the intra-coded picture a portion of a number of bits allocated to pictures subsequent to the intra-coded picture in the group of pictures.

19. The computer readable medium of claim 16, wherein signaling repetition of another picture comprises signaling repetition of one selected from a group consisting of a previous picture and the intra-coded picture.

20. The computer readable medium of claim 16, wherein the picture is a P-picture and the subsequent picture is one selected from a group consisting of a P-picture and a B-picture.
